(19) United States
(12) Patent Application Publication
(10) Pub. No.: US 2025/0312803 A1
(43) Pub. Date: Oct. 9, 2025

(54) Sparger Status Sensor System

(71) Applicant: Eriez Manufacturing Co., Erie, PA (US)

(72) Inventors: Michael J. Mankosa, Erie, PA (US); Ronald P. Krahe, Girard, PA (US); James Jukkola, Erie, PA (US); Leif Uhlman, Erie, PA (US)

(73) Assignee: Eriez Manufacturing Co., Erie, PA (US)

(21) Appl. No.: 19/244,833

(22) Filed: Jun. 20, 2025

Related U.S. Application Data
(63) Continuation-in-part of application No. 17/731,059, filed on Apr. 27, 2022, now Pat. No. 12,343,737.

(51) Int. Cl. B03D 1/02; B03D 1/24; G01D 21/02

(52) U.S. Cl. CPC B03D 1/028; B03D 1/24; G01D 21/02

(57) ABSTRACT

A network of sensor systems for spargers for injection of bubbles into a flotation system, comprising an air header to deliver a flow of compressed gas, a pressure transducer connected to the air header that measures pressure in the air header, a plurality of spargers that each receive a flow of compressed gas from the air header and that each comprise a sensor system. Flow measurement devices are located between the air header and each sparger. The pressure transducer, each sensor system, and each flow measurement device outputs a signal to a signal processor that generates a signal output to a central control unit that aggregates and analyzes each signal to display operating parameters of each corresponding sparger and provide overall system performance data.

This application is continuation-in-part of U.S. patent application Ser. No. 17/731,059 filed on Apr. 27, 2022 which is a continuation-in-part of U.S. Pat. No. 11,344,896 filed on Feb. 27, 2019, which claims priority from PCT Application No. PCT/US17/49743 filed on Aug. 31, 2017, which claims benefit of U.S. Provisional Patent Application No. 62/382,011 filed on Aug. 31, 2016.

### BACKGROUND

In mineral flotation applications, sparging systems are used to promote the attachment and recovery of hydrophobic particles through the generation of a fine bubble dispersion. This is accomplished by arranging a series of spargers in the periphery of flotation tanks. The spargers generate a large amount of bubbles at the optimum size for the given application. Specifically, they are designed to generate high rates of bubble surface area which guarantees a high probability of attachment and improved recoveries of hydrophobic particles. Smaller mineral processing plants could have as few as a single flotation tank while larger plants could have several dozen flotation tanks. Each flotation tank could have thirty spargers or more. This means that larger processing plants could easily have hundreds of spargers that represent a significant investment in equipment, maintenances, and repair.

Prior art spargers were essentially left to their own devices as it was difficult to monitor real time performance and provide feedback and troubleshooting for spargers that were operating inefficiently or not at all. It was only in routine maintenance that problems were uncovered, if at all.

What is presented is a sparger for the injection of bubbles into flotation systems which incorporates sensors and mechanisms that provide status indicators on the functioning of an individual sparger as well as systems for providing networked communications between a collection of spargers on a single flotation system or in a facility that has multiple flotation systems.

### SUMMARY

What is presented is network of sensor systems for spargers for injection of bubbles into a flotation system, comprising an air header to deliver a flow of compressed gas, a pressure transducer connected to the air header that measures pressure in an air header, and a plurality of spargers that each comprise a housing with an inlet configured to receive a flow of compressed gas from the air header. A movable rod assembly within each housing comprises a nozzle and a rod within the nozzle. The rod is connected to a diaphragm that is further connected to a spring such that compressed air entering the housing acts on the diaphragm to compress the spring and retract the rod from the nozzle.

Each sparger comprises a sensor system, wherein each sensor system further comprises a sensor and a target that move relative to each other, wherein one of the sensor and the target is located in the housing and the other is located or attached to the movable rod assembly. The sensor measures parameters of motion, position, and vibration relative to the target based on the movement of the movable rod assembly. A flow measurement device is located in line with the inlet. The sensor system determines operating parameters of the sparger based on analysis of the measured motion, position, and vibration of the sensor relative to the target and flow measurements from said flow measurement device.

The pressure transducer, each sensor system, and each flow measurement device output a signal to a signal processor and the signal processor generates a signal output to a central control unit. The central control unit aggregates and analyzes each signal to display operating parameters of each corresponding sparger and provide overall system performance data.

In some embodiments, the flow measurement device is positioned adjacent to said inlet. In other embodiments, the flow measurement device is positioned adjacent to the source providing said flow of compressed gas to the housing.

In some embodiments, the central control unit determines the presence of failure modes of the sparger including plugged nozzle, a torn diaphragm, loss of pressure, leaks, an eroded nozzle, an isolated sparger, a soiled flow measurement probe, and loss of fluid. Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a cut out view of a sparger operating at low pressure with the sparger in the closed position;

FIG. 2 is a cut out view of a sparger operating at high pressure with the sparger in the open position;

FIG. 3 is a flow chart outlining the process steps from the sensor system through the signal processor and its output;

FIG. 4 shows a series of spargers installed on a flotation tank networked wirelessly to a central control unit;

FIG. 5 shows a series of spargers with flow measurement devices connected to a central control unit; and

FIG. 6 shows a pressure transducer attached to the air header that supplies compressed air to a series of spargers each with flow measurement devices.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

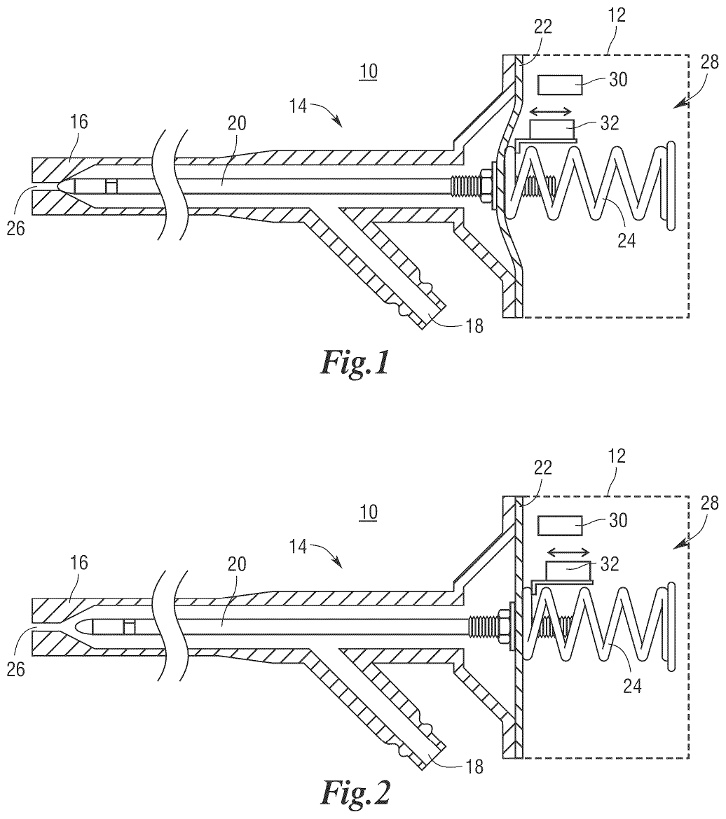

As shown in FIGS. 1 and 2, spargers 10 comprise a housing 12 and a movable rod assembly 14. The movable rod assembly 14 further comprises a nozzle 16 that is inserted into the liquid medium inside a flotation tank (not shown). A source compressed gas is connected to the inlet 18. A rod 20 is connected to a diaphragm 22 that is further connected to a spring 24. As shown in FIG. 1 when pressure is low, the spring 24 pushes the diaphragm 22 and the rod 20 into the nozzle 16 thereby sealing the nozzle tip 26 and preventing liquid from the flotation tank from flowing back into the sparger. As shown in FIG. 2, when higher pressure is applied by the introduction compressed gas from the inlet 18, the pressure acts on the diaphragm 22 to compress the spring 24, retracting the rod 20, and opening the nozzle tip 26 which allows the gas to be released through the nozzle tip 26 to create bubbles in the liquid medium in the flotation tank. In some embodiments, liquid may be added to the compressed gas stream at the inlet 18 to enhance bubble formation.

A sensor system 28 is mounted within the housing 12. The sensor system 28 comprises a sensor 30 and a target 32. In the embodiment shown in FIGS. 1 and 2 it is preferred that the sensor 30 is mounted in a stationary position within the housing 12 while the target 32 is linked with the movable rod assembly 14 such that the target 32 moves in concert with the movable rod assembly 14. The figures show that the target 32 is connected to the spring 24 but it should be understood that the actual mounting location of the target 32 to the movable rod assembly 14 is immaterial so long as the movement of target 32 is an accurate reflection of the movement of the movable rod assembly 14. It is understood that the position of the target 32 and the sensor 30 could be switched such that the target 32 is stationary while the sensor 30 moves with the movable rod assembly 14. The sensor system 28 will operate identically in either configuration.

The sensor system 28 could be any type of system that has a sensor 30 that measures the motion, including position and vibration, of a target 32 based on the movement of the movable rod assembly 14. Examples include Hall Effect sensors and other magnetic sensors, optical sensors for visual recognition of a reflective target, and inductive sensors with a metallic target. Depending on the type of sensor used, the target 32 does not have to be a separate element from the movable rod assembly 14 as is depicted in FIGS. 1 and 2. Components of the movable rod assembly 14 itself could be the target 32. So long as the sensor is able to detect and measure motion, including position and vibration, of the movable rod assembly 14, then the purpose of the target 32 is met without any additional element being present. The target 32 could be the spring 24, a nut or washer on the movable rod assembly 14, or even the rod 20. In some embodiments, the target 32 could be a ring that is mounted concentric to the rod assembly 14. The advantage of a ring shaped target 32 is that placement of the target relative to the sensor system 28 does not require the target 32 to be placed on the rod assembly 14 in any specific orientation, which simplifies assembly of the sparger 10 and makes the sparger 10 more robust. The target 32 is prone to rotating on the road assembly 14 while assembling the sparger 10 and adjusting the rod assembly 14. A ring-shaped target 32 ensures this rotation does not move the target 32 out of the range of the sensor 30. The target could be any magnet. If the target is a magnet, ceramic magnets are preferred due to their moisture resistance.

With the sparger 10 in the closed position as shown in FIG. 1, the sensor 30 determines the motion of the target 32 relative to it. With no movement the sensor system 28 is able to determine that no gas is passing through the sparger 10 and that the sparger 10 is not in operation. When higher pressure is applied by the introduction of compressed gas from the inlet 18, as shown in FIG. 2, the rod 20 moves and vibrates as fluid flows through the sparger 10 and the nature of these vibrations provides an indication of the functioning of the sparger 10. The output from the sensor 30 is an indirect measure of the pressure at which compressed gas is introduced through the inlet 18 and provides operating parameters and failure modes of the sparger 10. The measured motion of the target 32 relative to the sensor 30 indicates the position and motion of the rod 20 and is a measure of the opening of the nozzle tip 26. Minimum useful indication would be “fully open” vs. “not fully open”. More nuanced sensors could measure continuous position changes in the rod 20 or percentage opening of the nozzle tip 26 from fully closed to fully open. If the sparger 10 is plugged, the sensor 30 would record that the rod 20 will move but that it doesn't vibrate. If the diaphragm 22 tears, pressure drops and a partial position change of the rod 20 will be recorded as the rod 20 would not be able to move as far because the compressed gas has another outlet to escape.

Measurements from the sensor system 28 could be combined with measurements of other sparger 10 parameters to get a more accurate reading on system performance. For example, the interpretations of the readings from the sensor system 28 could be correlated with direct measurement of the compressed gas flow from the inlet 18 using, for example, a vane flow sensor, a hot wire flow sensor, differential pressure measurement across an orifice, differential temperature measurement across an orifice, or a microphone to sense flow noise. So, for example, a determination that a nozzle 16 is plugged based on a reading from the sensor system 28 can be correlated with a reading from the compressed gas flow to confirm whether and to what extent compressed gas is flowing into the sparger 10.

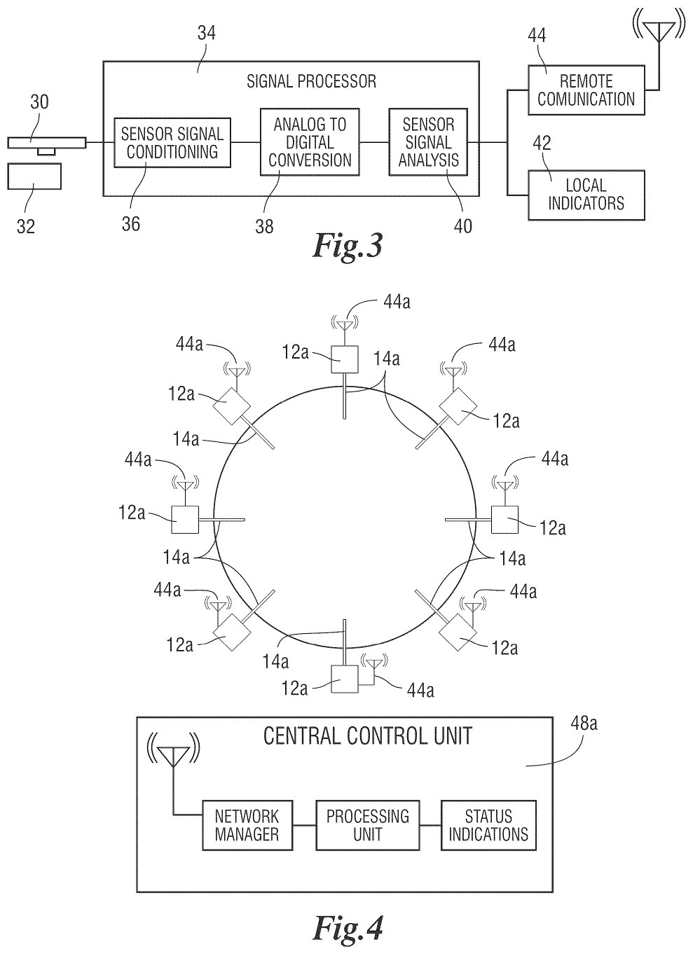

Whatever the readings of the sensor system 28, FIG. 3 shows how those readings are communicated to an operator for analysis and to determine operation status. Signals from the sensor 30 are transmitted to a signal processor 34 where they are conditioned 36 and converted to a digital signal 38 for further analysis 40. The signal is scaled based on stored calibration values and compared to threshold setpoints to determine whether the sparger 10 is in the expected operating conditions. The results of the analysis can be output to local indicators 42 at the sparger 10 by, for example, LED indicators on the housing or some other display or output. The results can also be transmitted via remote communications 44 to a central control unit 48a as shown if FIG. 4 by radio communications, along with the raw sensor data, if desired. Various embodiments of the sensor system may have only local indicators 42, only remote communications 44, or both. In various embodiments, the remote communications 44 may be wireless, wired, or both as needed for the particular application.

FIG. 4 shows an embodiment of how the remote communications 44a systems of a sensor system housed within a system of spargers 10a can be configured to form a network of sensor systems. In this example, a series of spargers 10a is installed in a flotation tank 46a. The remote communications 44a from each sparger 10a may be wired or wirelessly connected to a central control unit 48a which receives, aggregates, and analyzes the information from all spargers and displays the overall system status to the operator. The central control unit 48a may display and/or store the data locally, forward the data to another control system, or both.

The central control unit 48a aggregates the status information from multiple spargers and may perform additional analysis on the data. This includes comparing data from one sparger (or group of spargers) with another sparger (or group of spargers). The central control unit 48a could also correlate sparger data with data from other types of sensors or status indicators that may be available in the plant. For example, if all of the spargers in the plant are closed, the central control unit 48a could be directed to check the status of the air compressor rather than indicating that all of the spargers are faulty. In addition, the central control unit 48a could compare data from one or more spargers over time, looking at trends and variations.

The central control unit 48a could also display status indications in some aggregate form to clearly inform the operator how many spargers are not operating correctly and where the offenders are located in the plant. The status could be presented in a graphical display, possibly with a touchscreen for user interaction, discrete indicators, or Integrated into a larger (e.g. plant-wide) control/indication system.

The central control unit 48a could communicate status remotely to plant operators, supervisors, and/or others if desired. This could include, but is not limited to, fault alerts, horns, beacons, loudspeaker annunciator, email, text message, real-time status information, remote PC, or a smartphone application.

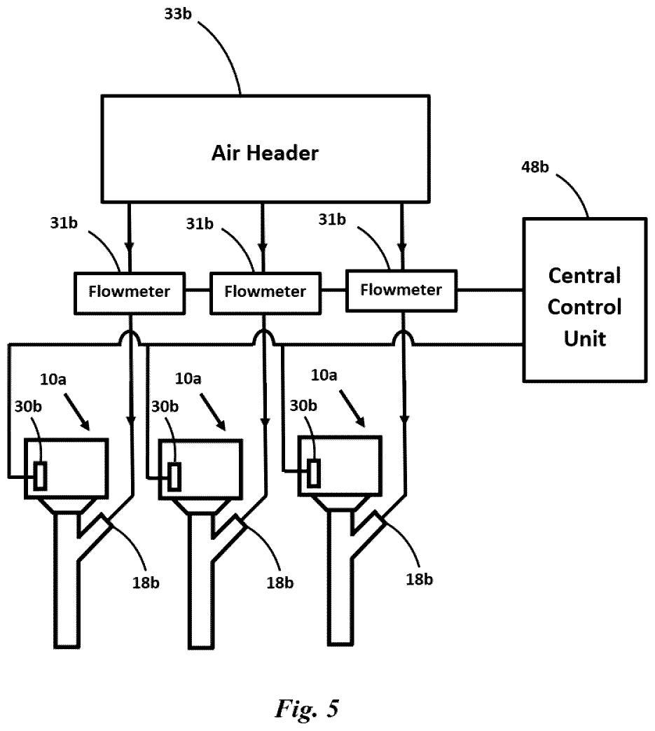

Air is typically suppled to a sparging system from a central source and distributed to each sparger in the sparging system via an air header. As shown in FIG. 5, a flow measurement device 31b may be positioned upstream of each sparger 10b to take flow measurements of the compressed gas from the air header 33b. The flow measurement devices 31b could be any of a vane flow sensor, a hot wire flow sensor, differential pressure measurement across an orifice, differential temperature measurement across an orifice, a microphone to sense flow noise, or any other commercially available flow measuring device. Flow measurement devices 31b may be positioned adjacent to the inlet 18b of the sparger or further upstream adjacent to the air header 33b. Data from each sensor 30b and each flow measurement device 31b may be transmitted to a central control unit 48b either remotely or through a wired connection. Each sparger 10b may be independently operated by the central control unit 48b through an automated valve such as a solenoid valve or motorized valve (not shown). If failure modes of a sparger 10b are detected in the data from the sparger's sensor 30b and/or the flow measurement device 31b, the central control unit 48b may shut off the sparger 10b and indicate that service is required. Flow measurements from the flow measurement device 31b may be compared with the data from the sensor 30b during operation of the sparger 10b to detect the presence of failure modes of the sparger 10b including any of a plugged nozzle, a torn diaphragm, loss of pressure, leaks, loss of fluid, and other abnormal flow characteristics.

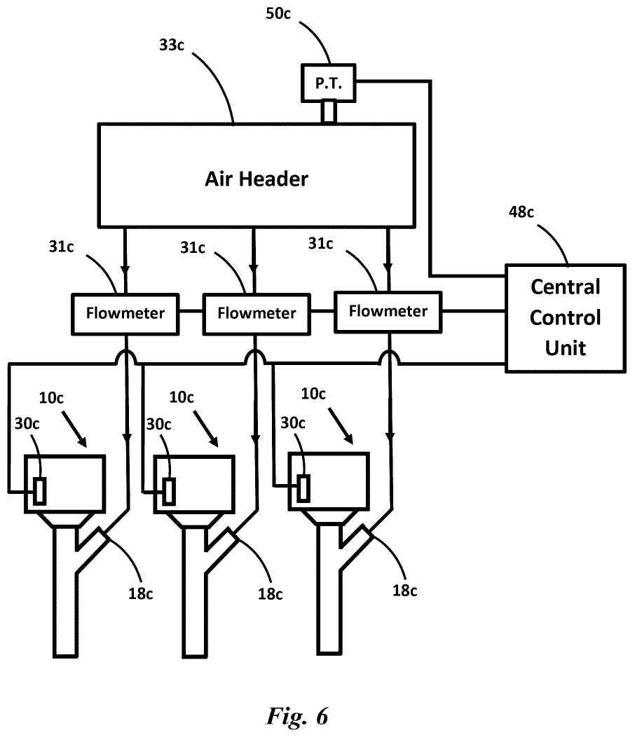

FIG. 6 presents a variation of the system presented in FIG. 5. A pressure transducer 50c that measures pressure is connected to the air header 33c that supplies compressed air to each sparger 10c. There is one pressure transducer 50c per flotation system with each flotation system having multiple spargers 10c serviced by the same air header 33c. As with the previous embodiments, flow measurement devices 31c are positioned upstream of each sparger 10c to take flow measurements of the compressed gas from the air header 33c. The flow measurement devices 31c could be any of a vane flow sensor, a hot wire flow sensor, differential pressure measurement across an orifice, differential temperature measurement across an orifice, a microphone to sense flow noise, or any other commercially available flow measuring device. Flow measurement devices 31c may be positioned adjacent to the inlet 18c of the sparger or further upstream adjacent to the air header 33c. Data from each sensor 30c and each flow measurement device 31c may be transmitted to a central control unit 48c either remotely or through a wired connection. Each sparger 10c may be independently operated by the central control unit 48c through an automated valve such as a solenoid valve or motorized valve (not shown). If failure modes of a sparger 10c are detected in the data from the sparger's sensor 30c and/or the flow measurement device 31c, the central control unit 48c may shut off the sparger 10c and indicate that service is required. Flow measurements from the flow measurement device 31c may be compared with the data from the sensor 30c during operation of the sparger 10c to detect the presence of failure modes of the sparger 10c including any of a plugged nozzle, a torn diaphragm, loss of pressure, leaks, loss of fluid, and other abnormal flow characteristics.

The pressure in the air header 33c, measured by the pressure transducer 50c, is a common variable that the flow from the flow measurement device 31c and the rod position from the sensor 30c from each sparger 10c on the flotation system can be checked against. Measuring the pressure enables the determination of failure modes that were not possible to diagnose with just the flow measurement device 31c and sensor 30c readings alone. The pressure readings also provide higher levels of confidence when detecting certain types of errors.

The addition of the pressure transducer 50c to the system allows the creation of three relationship models for each sparger 10c: the Flow-Pressure profile, the Rod Position-Pressure profile, and the Flow-Rod Position Profile. These are complex relationships due to the mechanical components that make up elements of the sparger 10c, in particular, the rod assembly that has been previously described with other embodiments. Other factors that impact these relationships are the nozzle orifice diameter, spring rate, fluid compressibility, turbulence, the pressure inside the flotation system, and the material properties of the rubber and fabric reinforcement that make up the diaphragm, all of which have been previously described with other embodiments. Adding another fluid, such as water, downstream from the flow measurement device 31c adds further complexity to these relationships.

The Flow-Pressure profile models the expected air flow rate through the sparger 10c for a given header 33c pressure. The Rod Position-Pressure Profile models the expected rod position for a given header 33c pressure. The Flow-Rod Position Profile models the expected air flow rate for a given rod position. The expected performance of a sparger 10c is defined by these relationships, and each sparger's 10c process variables are constantly checked against these profiles to analyze the performance of the sparger 10c in real time. These profiles can be modeled for spargers of different sizes.

The pressure transducer 50c allows many error conditions to be diagnosed including whether the sparger 10c is isolated from the flotation system. All spargers 10c have an isolation valve (not shown) that seals their airline from the air header 33c. This isolation valve is used when installing or servicing a sparger 10c while the air header 33c is pressurized. This valve could be left closed accidentally after service is complete. An isolated valve can be identified when the central control unit 48c registers a pressurized manifold, zero air flow, and a fully closed rod position. The air flow and rod position measured by the flow measurement device 31c and the sensor 30c will not deviate from the Flow-Rod position profile, but they will deviate from the Flow-Pressure and Rod Position-Pressure profiles. Without the pressure transducer 50c measuring the header pressure, rod position would have to be verified against the rod positions of the other spargers 10c on a flotation system.

The pressure transducer 50c also allows determining whether a sensor probe of a flow measurement device 31c is soiled. Creating clean compressed air at large volumes can be uneconomical or unfeasible. Droplets of compressor oil are carried in the air flow through the air system and eventually make their way into the flotation system via the spargers 10c. The droplets of oil condense on the flow sensor probes for the flow measurement devices 31c over time, causing a low flow sensor measurement.

The flow sensor of many flow measurement devices 31c operates on the calorimetric measuring principle, which means that a layer of oil on the measuring probe will reduce the rate of heat transfer out of the flow measurement device 31c to the flow stream. The flow sensor interprets the reduced heat transfer rate as a lower flow velocity, leading to an inaccurate measurement. The low flow reading will deviate from the expected Flow-Rod Position profile and the Flow-Pressure profile. However, the measured rod position will not deviate from the expected position defined by the Rod Position-Pressure profile. The pressure transducer 50c allows this condition to be set as an alert condition by the central control unit 48c to an operator that a flow sensor probe for a particular flow measurement device 31c needs to be cleaned.

The pressure transducer 50c also allows estimation of liquid flow in the system. Knowing the air flow rate, rod position, and pressure allows an estimation of the flow rate of water added in line with the sparger 10c. For example, adding water to the sparger 10c downstream from the air flow sensor of a flow measurement device 31c may reduce the volumetric air flow rate for a given air header pressure while increasing the rod opening to allow additional mass flow to pass through the nozzle of the sparger 10c. These changes would vary according to the water flow rate and could be used to estimate the water flow rate when compared to sparger 10c that operates with air only. This configuration allows the central control unit 48c to determine the presence of failure modes of the sparger including a plugged nozzle, a torn diaphragm, loss of pressure, leaks, an eroded nozzle, an isolated sparger, a soiled flow measurement probe, and loss of fluid.

Many mineral processing systems have multiple flotation systems. It is preferred that each flotation system has its own air header 33c with each air header 33c having its own pressure transducer 50c. The signal output from each flotation system is transmitted to a central control unit wirelessly or through a wired connection.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A network of sensor systems for spargers for injection of bubbles into a flotation system, comprising:
an air header to deliver a flow of compressed gas;
a pressure transducer connected to said air header that measures pressure in said air header;
a plurality of spargers that each comprise a housing with an inlet configured to receive a flow of compressed gas from said air header;
a movable rod assembly within each housing comprising a nozzle and a rod within said nozzle, said rod connected to a diaphragm that is further connected to a spring such that compressed air entering said housing acts on said diaphragm to compress said spring and retract said rod from said nozzle;
each said sparger comprising a sensor system, wherein each said sensor system further comprises a sensor and a target that move relative to each other, wherein one of said sensor and said target is located in said housing the other is located or attached to said movable rod assembly, said sensor for measuring parameters of motion, position, and vibration relative to said target based on the movement of said movable rod assembly, a flow measurement device in line with said inlet, and said sensor system for determining operating parameters of the sparger based on analysis of the measured motion, position, and vibration of said sensor relative to said target and flow measurements from said flow measurement device; and
said pressure transducer, each said sensor system, and each flow measurement device outputs a signal to a signal processor and said signal processor generates a signal output to a central control unit, wherein said central control unit aggregates and analyzes each said signal to display operating parameters of each corresponding said sparger and provide overall system performance data.

2. The network of sensor systems of claim 1 wherein said flow measurement device is positioned adjacent to said inlet.

3. The network of sensor systems of claim 1 wherein said flow measurement device is positioned adjacent to the source providing said flow of compressed gas to said housing.

4. The network of sensor systems of claim 1 in which said central control unit determines the presence of failure modes of the sparger that is any one of a plugged nozzle, a torn diaphragm, loss of pressure, leaks, an eroded nozzle, an isolated sparger, a soiled flow measurement probe, and loss of fluid.
